(19) United States
(12) Patent Application Publication
(10) Pub. No.: US 2005/0063293 A1
(43) Pub. Date: Mar. 24, 2005

(54) Optical disk with tracking grooves similar to blazed grating

(76) Inventors: Anatoly M. Smolovich, Moscow (RU); Igor A. Levitsky, Fall River, MA (US); Oleg B. Serov, Moscow (RU); A. O. Serov, Moscow (RU)

Correspondence Address: Igor A. Levitsky;Emitech, Inc., 476 Locust St., Suite 5, Fall River, MA, 02720, US

(21) Appl. No.: 10/942,057

(22) Filed: Sep. 15, 2004

Related U.S. Application Data
(60) Provisional application No. 60/503,871, filed on Sep. 22, 2003.

(51) Int. Cl. G11B 7/00; G11B 7/24

(52) U.S. Cl. 369/275.4; 369/44.26; 369/111

(57) ABSTRACT

The proposed the multilayer optical disk with slant tracking grooves, which are similar to the blazed diffraction grating grooves. The different incline of the grooves in the neighbor layers of the multilayer optical disk considerably reduce the interlayer cross-talks. This allows to decrease the distance between the neighbor layers resulting in a high 3D capacity. Both consecutive and parallel information reading from the different layers are possible. Parallel reading in this case can be performed with enhanced speed. Also, the capacity can be increased due to the exclusion of the spaces between data recording grooves that exist in the conventional disks. This advantage is employed in the design of the proposed disk making it fully compatible with the standard reading system.

Provisional patent (APPL. No. 60/503,871) was filed by Sep. 22, 2003

### REFERENCES CITED

### U.S. Patent Documents

| | | | |
|---|---|---|---|
| 4090031 | May 1978 | Russell | 358/130 |
| 4310916 | January 1982 | Dil | 369/109.02 |
| 4325135 | April 1982 | Dil et al | 369/109.02 |
| 4450553 | May 1984 | Holster et al. | 369/94. |
| 4534021 | August 1985 | Smith | 369/47 |
| 4569038 | February 1986 | Nagashima | 369/44. |
| 4744070 | May 1988 | Takemura et al. | 369/44.26 |
| 5126996 | June 1992 | Iida et al. | 369/283. |
| 5202875 | April 1993 | Rosen et al. | 369/94. |
| 5251198 | October 1993 | Strickler | 369/110. |
| 5303225 | April 1994 | Satoh | 369/275.3 |
| 5373499 | December 1994 | Imaino et al. | 369/275.4 |
| 5511057 | April 1996 | Holtslag et al. | 369/94. |
| 5608715 | March 1997 | Yokogawa et al. | 369/275. |
| 5615186 | March 1997 | Rosen et al. | 369/44.24 |
| 5625609 | April 1997 | Latta et al. | 369/94. |
| 5627816 | May 1997 | Ito et al. | 369/275.1 |
| 5640382 | June 1997 | Florczak et al. | 368/275.1 |
| 5645908 | July 1997 | Shin | 428/64.1 |
| 5702792 | December 1997 | Iida et al. | 428/64.1 |
| 5708652 | January 1998 | Ohki et al. | 369/275. |
| 5745473 | April 1998 | Best et al. | 369/275.1 |
| 5761187 | June 1998 | Kaneko et al. | 369/275.1 |
| 5764619 | June 1998 | Nishiuchi et al. | 369/275.1 |
| 5766717 | June 1998 | Kaneko et al. | 428/64.1 |
| 5828648 | October 1998 | Takasu et al. | 369/275.1 |
| 5871881 | February 1999 | Nishida et al. | 430/270.11 |
| 5878018 | March 1999 | Moriya et al. | 369/275.1 |
| 5987002 | November 1999 | Fukumoto et al. | 369/110.04 |
| 5989670 | November 1999 | Kaneko et al. | 428/64.1 |
| 6030678 | February 2000 | Aratani | 428/64.1 |
| 6083598 | July 2000 | Ohkubo et al. | 428/64.1 |
| 6160787 | December 2000 | Marquardt, Jr. et al. | 369/275.1 |
| 6241843 | June 2001 | Kaneko et al. | 156/245 |
| 6537637 | March 2003 | Kaneko et al. | 428/64.1 |

### Other References

Yang et al., “Interlayer cross talk in dual-layer read-only optical disks” Applied Optics, 38, 333 (1999).

### BACKGROUND OF THE INVENTION

The use of multiple data layers is an effective way to increase the capacity of an optical disk. Different variants of such disks were proposed in many patents (for example U.S. Pat. Nos. 4,090,031; 4,450,553; 5,126,996; and 6,241,843). The semitransparent layers that were used there are thin (few nanometers), metal films placed inside the transparent polymeric material. Each layer contains the preformed tracking grooves with information pits recorded inside each groove. The reading beam is scattered by pits and is reflected by the smooth parts of the layer. The relief depth of the data layer is less than one micrometer, while the usual disk thickness is 1.2 mm. Therefore, the employment of the third dimension has great potential for the enhancement of the disk capacity.

However, the technological development in this direction is limited due to the interlayer cross-talks during the optical reading. To reduce the interlayer cross-talks the distance between layers should be increased. On the other hand, there are difficulties with the spherical aberration at the large interlayer separation: the marginal light rays are focused at a higher point than central rays due to the influence of the substrate. The aberration can be compensated only for a certain distance from the optical disk surface to the plane of focusing (U.S. Pat. Nos. 5,251,198 and 5,625,609). For this reason the thickness of the optical disk substrates should not exceed 100 micrometers. That limits the number of data surfaces, which could be practically realized. Thus, the above obstacles currently prevent the design of new 3D optical disks with a super-high capacity.

V-shaped grooves were proposed for the single data layer optical disks (for example U.S. Pat. No. 4,534,021) where the neighbor grooves containing the information pits were inclined in opposite directions. This allowed to decrease the crosstalks between the neighbor grooves and gave the possibility of increasing the disk capacity.

Another way to increase the disk capacity is the so-called land and groove recording (U.S. Pat. No. 5,987,002). In this case the preformed tracking grooves and the spaces between the grooves with other depth (lands) are made with equal width. Then information pits are placed both on the grooves and the lands. It is important that both V-shaped grooves and land and groove recording are not fully compatible with the standard reading system because information should be read sequentially from the two tracks.

### BRIEF SUMMARY OF THE INVENTION

In the present invention, we propose the special design of the data layers possessing the guide grooves for tracking with a radial section near right triangle. The surface of said groove containing information pits is tilted with respect to the disk plane. So, these grooves are analogous to the blazed diffraction grating grooves. The groove's surfaces are tilted differently for the neighbor layers. This allows directing the reflected signals from neighbor layers to the different photodetectors. Options with a single objective and several objectives for the information reading are possible. In such a design the cross-talks between neighbor layers should be significantly reduced. Consequently, the distance between the neighbor layers can be decreased resulting in a high 3D capacity. The information reading from several data layers could be performed consequently or parallel (which provides a high reading speed). The proposed optical disk data layers could be formed one by one from the corresponding master disks by the known printing technology.

### BRIEF DESCRIPTION OF THE DRAWINGS

FIG. 1 The schematic cross sectional view showing essential portions of the structure of the multilayer optical disk with consecutive reading;

FIG. 2 The enlarged fragment of the groove: a—view from the top, b—radial cross section;

FIG. 3 The schematic cross sectional view showing essential portions of the structure of the multilayer optical disk with a parallel reading;

FIG. 4 The enlarged fragment of the data layers of the optical disk shown on FIG. 3;

FIG. 5 The optical disk with concentric relief diffraction grating.

### DETAILED DESCRIPTION

### FIRST EMBODIMENT

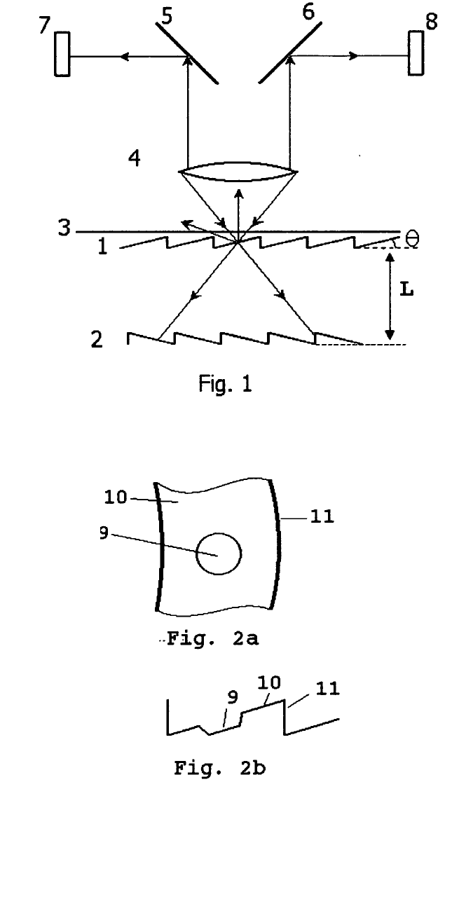

The cross-section of the optical disc cut along the radial direction of the disk according to the preferred embodiment is shown in FIG. 1. Here 1 and 2 are the neighbor layers of the disk, 3 is the disk surface through which the reproducing laser beam is directed. In general, the optical disk can contain more layers. The groove surfaces of layer 1 are inclined at angle of .theta. to the disk plane. The groove surfaces of layer 2 are inclined at the same angle but in the opposite direction. The enlarged groove scheme is shown in FIG. 2a, b. FIG. 2a is a view from the top and FIG. 2b is a cross-section along the radial direction. The information pits 9 are placed only on the working surface 10 of the groove. The second surface 11 of the groove is approximately normal to the disk plane or to the plane of the working surface 10. The reading beam is focused on the layers through the objective lens 4 by a standard technique. The illuminating leg is not shown in FIG. 1. The reading beam axis is normal to the disk plane. The reading beam is scattered or reflected from the grooves area which contains or does not contain the information pit, respectively. The reflected beam has a conical form and its axis is inclined on the 2.theta.angle to the disk normal. If 2.theta.=arc sin(NA), where NA is the objective numerical aperture, the main part of the beam intensity reflected by layer 1 will be at the left side to the objective axis. Contrary, the beam reflected from the layer 2 will be at the right side to the axis. Therefore, these two beams can be directed by mirrors 5 and 6 to the different photodetectors 7 and 8. When the reading beam is focused on layer 1, layer 2 is illuminated by a defocused beam. The diameter of the light spot on layer 2 is of 2L×NA, where L is the distance between layers 1 and 2. Several grooves of layer 2 will be illuminated by the defocused beam and the reflected light from layer 2 is a result of the interference of the waves scattered by the illuminated grooves. Thus, the illuminated area of layer 2 operates similarly to the part of blazed diffraction grating. It is known, that the signal reflected by the diffraction grating can be considered as a product of two angular depended functions. The first one describes the radiation scattering by one groove. The second one describes the interference of waves scattered by different grooves. Thereby, the main reflected radiation energy would be carried by the diffraction orders, which propagate inside the single groove directivity diagram. In our case it means that the main energy of light reflected by layer 2 would propagate to the right side from the objective axis. Thus, in the preferable embodiment, the light reflected from layer 2 will be out of photodetector 7, that should significantly reduce the interlayer cross-talks.

### SECOND EMBODIMENT

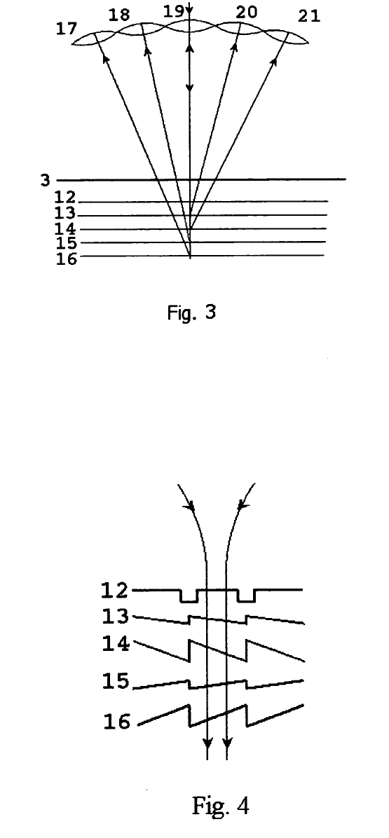

In the second embodiment we demonstrate a proposed design that provides the opportunity for the parallel reading. The projecting objective aperture NA is of 0.2, which is less than the standard value (0.45). That results in a large diameter of the focus spot (proportional to .lambda./NA, where .lambda. is radiation wavelength) and the increase of the focus depth, which is proportional to .lambda./(NA)². The later allows us to perform parallel information reading from the group of neighbor layers by a single beam. FIG. 3 shows the cross-section of the optical disc containing the group of five layers, say 12, 13, 14, 15 and 16. The distance between the outer layers 12 and 16 is less than the focus depth. The layer grooves are not shown on FIG. 3, however they are seen on the enlarged section of the data layers (FIG. 4). Here layer 12 contains the standard grooves with horizontal working surfaces. The other layers (13, 14, 15, and 16) have grooves with working surfaces inclined on different angles. The signals reflected from the grooves of layers 12, 13, 14, 15 and 16 are accordingly directed to the reading objectives 17, 18, 19, 20, and 21 (FIG. 3), which have their own photodetectors. Also the objective 19 is used for focusing illuminating beam. Thus, the signals from the group of layers can be read in parallel increasing the reading speed. Note, that decreasing the projection objective aperture in M times will increase the focus spot size in M times. So, the capacity of one data layer would decrease by M² times. On the other hand in this case the focus depth would increase by M² times. That circumstance allows to increase by M² times the number of data layers within the focal depth. Hence, the total capacity of the group of data layers within the focal depth remains the same while the reading speed is increased by M² times since a number of parallel reading layers is increased in M² times. Moreover, for the special case, information layers could be placed very close to each other within focal depth without aperture decreasing. In this case both the disk capacity and the reading speed would be increased.

### THIRD EMBODIMENT

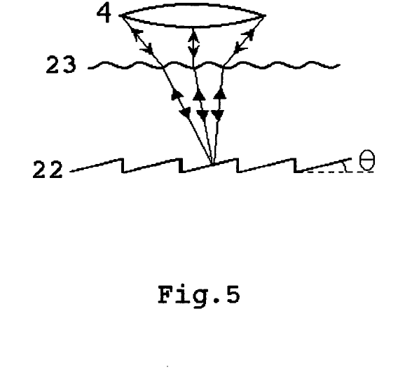

One more advantage of the proposed blazed-like grooves structure is the exclusion of the space between data recording grooves. As a result, the working area of the optical disk could be increased to more than 30% and consequently the disk capacity would be increased by the same number. In the previous embodiments the multiple photodetectors were used. Their spatial separation was due to the different tilts of the signal beams. In the third embodiment, the tilt of the signal beam is not necessary condition and can be compensated by using the special diffraction grating. The cross-section of the optical disc containing only one layer 22 with blazed-like grooves structure is shown in FIG. 5. The grooves surfaces of layer 22 are inclined at angle .theta. to the disk plane. Concentric relief diffraction grating 23 is fabricated on the disk surface through which the reproducing laser beam is directed. The grating period is equal .lambda./sin(.theta.). The reading beam axis is normal to the disk and the beam is defocused in the region of grating 23. The beam diffraction has occurred, so that the first diffraction order is directed normally to the grooves surface. The beam reflected by the groove can be also diffracted by grating 23 the same way, so that the first diffracted order is directed normally to the disk. Thus, such a disk can be read by the standard optical disk reading equipment. It is desirable to concentrate the main energy in the one working order of the diffraction grating. This could be done by using the special grating grooves profile (not shown on FIG. 5). The scheme with concentric diffraction grating on the disk surface can also be applied to the optical disk containing several data layers with the same incline angle of grooves working surface. In this case the interlayer cross-talks would be the same as in the known multiple-layer optical disks. However its capacity would be increased due to minimal space between the data recording grooves.

1. An optical disk of the type from which the recorded information is reproduced by focusing a laser beam thereon with an objective lens and detecting the reflected light beams with photodetectors, said optical disk comprising:
a main disk body made from a material substantially transparent to radiation with which the recorded information is to be reproduced,
at least one reflective or partly reflective data layer placed inside said main disk body,
said data layer having spiral or concentric guide grooves for tracking,
each of said groove having a cross-section in the radial direction of said disk near to right triangle with a first side wall and a second side wall,
the surface of said first side wall is inclined at some angle with respect to the optical disk plane,
said surface of said first side wall contains information pits,
the surface of said second side wall is approximately normal to said surface of said first side wall or to the optical disk plane,
said surface of said second side wall does not contain information pits.

2. An optical disk according to claim 1, comprising a plurality of said data layers, wherein at least two data layers of said plurality have said guide grooves for tracking with the different slant of the surfaces containing information pits.

3. An optical disk according to claim 1, comprising at least one reflective or partly reflective data layer having the guide grooves for tracking of a standard form without slant of the surfaces containing information pits.

4. An optical disk according to claim 2, comprising at least two adjacent data layers of said plurality of data layers,
wherein the first data layer from said adjacent data layers has the guide grooves for tracking with the surface containing information pits,
said surface of said first data layer is inclined at an angle .theta. with respect to optical disk plane measured from the radius-vector directed to the center of the optical disk,
where .theta.=½ arc sin(NA),
where NA is the numerical aperture of the focusing objective lens,
the second data layer from said adjacent data layers has the guide grooves for tracking with the surface containing information pits,
said surface of said second data layer is inclined at an angle equal 180 .degree. minus .theta.

5. An optical disk according to claim 2, comprising at least one group of reflective or/and partly reflective data layers,
wherein said data layers of said group have the guide grooves for tracking with the different slant of the surfaces containing information pits,
wherein the maximum distance between two of said data layers of said group is less than the focus depth of the objective lens, which is proportional to .lambda./(NA)², where .lambda. is the reproducing wavelength.

6. An optical disk according to claim 1, comprising a concentric transmitting phase relief diffraction grating disposed on the disk surface through which the reproducing laser beam is directed.

7. A method of reproducing information recorded on an optical disk, said optical disk comprising:
a main disk body made from a material substantially transparent to radiation with which the recorded information is to be reproduced,
a plurality of reflective or/and partly reflective data layers placed inside said main disk body, wherein at least one data layer of said plurality of data layers has spiral or concentric guide grooves for tracking,
each of said groove having a cross-section in the radial direction of said disk near to right triangle with a first side wall and a second side wall,
the surface of said first side wall is inclined at some angle with respect to the optical disk plane,
said surface of said first side wall contains information pits,
the surface of said second side wall is approximately normal to the said surface of said first side wall or to the optical disk plane,
said surface of said second side wall does not contain information pits,
wherein at least two data layers of said plurality of data layers have the guide grooves for tracking with the different slant of the surfaces containing information pits,
said method comprising the steps of:
focusing of the laser beam spot by the objective lens onto the data layers,
directing of the light beams reflected from data layers onto the photodetectors,
wherein the light beams reflected from data layers having the guide grooves for tracking with the different slant of the surfaces containing information pits. are directed onto the different photodetectors.

8. A method according to claim 7, wherein said focusing is performed sequentially onto one by one of data layers of said plurality of data layers.

9. A method according to claim 7, wherein said optical disk comprises at least one group of reflective or/and partly reflective data layers placed inside said main disk body, wherein the maximum distance between two of said data layers of said group is less than the focus depth of the objective lens, which is proportional to .lambda./(NA)², where .lambda. is the reproducing wavelength, said data layers of said group have the guide grooves for tracking with the different slant of the surfaces containing information pits, said focusing is performed simultaneously onto all data layers of said group, and said detection of the light beams reflected by said data layers of said group is performed in parallel.
